(19) United States
(12) Patent Application Publication
(10) Pub. No.: US 2019/0373618 A1
(43) Pub. Date: Dec. 5, 2019

(54) Wireless Communication Devices and Methods for Sidelink Interference Coordination in a Wireless Communication Network

(71) Applicant: HUAWEI TECHNOLOGIES CO., LTD., Shenzhen (CN)

(72) Inventors: Daniel MEDINA, Munich (DE); Serkan AYAZ, Munich (DE)

(21) Appl. No.: 16/545,825

(22) Filed: Aug. 20, 2019

Related U.S. Application Data
(63) Continuation of application No. PCT/EP2017/054122, filed on Feb. 23, 2017.

(51) Int. Cl. H04W 72/08; H04W 4/46; H04W 76/14; H04W 24/10

(52) U.S. Cl. CPC H04W 72/082; H04W 24/10; H04W 76/14; H04W 4/46

(57) ABSTRACT

The present disclosure relates to wireless communication devices for communication in a wireless communication network supporting a plurality of sidelink radio resources. One example wireless communication device comprises at least one processor configured to determine an interference-related parameter Hⱼ(s) associated with at least one of the plurality of sidelink radio resources (s), and at least one of compute a first map (Sⱼ) mapping an identity-related parameter (IDᵢ) of the at least one neighboring wireless communication device to Pᵢⱼ or compute a second map (Cⱼ) mapping at least one sidelink radio resource (s) to Iⱼ(s) or Hⱼ(s). A transceiver in the example wireless communication device is configured to transmit at least one of Sⱼ or Cⱼ to at least one of a network entity or at least one neighboring wireless communication device.

### CROSS-REFERENCE TO RELATED APPLICATIONS

This application is a continuation of International Application No. PCT/EP2017/054122, filed on Feb. 23, 2017, the disclosure of which is hereby incorporated by reference in its entirety.

### TECHNICAL FIELD

The present invention relates to wireless communications. More specifically, the present invention relates to wireless communication devices and methods for communication in a communication network, in particular, a Vehicle-to-Vehicle (V2V) communication network.

### BACKGROUND

The 3^{rd} Generation Partnership Project (3GPP) is in the process of enhancing Long Term Evolution (LTE) specifications toward 5G for supporting V2X (Vehicle-to-Everything) services.

In a V2V, or more generally, a V2X communication network, information can be exchanged among User Equipments (UEs), e.g., vehicles, either via the LTE-Uu interface by means of a base station (i.e., uplink/downlink), or directly Device-to-Device (D2D) via the PC5 interface (i.e., sidelink (SL)). The direct communication mode is supported when the UE is served by E-UTRAN and when the UE is outside of E-UTRA coverage (see 3GPP TS 36.300, “Evolved Universal Terrestrial Radio Access (E-UTRA) and Evolved Universal Terrestrial Radio Access Network (E-UTRAN); Overall description; Stage 2 (Release 14)”, September 2016, V14.0.0). In particular, there are two sidelink transmission modes (see 3GPP TS 36.213, “Evolved Universal Terrestrial Radio Access (E-UTRA); Physical layer procedures (Release 14)”, September 2016, V14.0.0). In the scheduled mode (SL transmission modes 1 and 3), the operator acts as a centralized coordinator for sidelink resource allocation for direct transmission over the PC5 interface, while, in autonomous mode (SL transmission modes 2 and 4), the UEs autonomously select sidelink resources from (pre)configured resource pools for direct transmission over the PC5 interface.

In V2X sidelink communication, the problem of sidelink resource allocation (or sidelink scheduling) has to be addressed, i.e., how to schedule radio transmissions in the communication network with minimal interference.

In order to prevent mutual interference among Physical Sidelink Shared Channel (PSSCH) transmissions which use the same carrier frequency in a given cell, different terminals (UEs) can be scheduled to transmit at different times (i.e., different subframes) and/or on different subchannels (i.e., different resource blocks). However, in order to increase the system capacity as well as to reduce channel access delay, it is desirable to allow multiple transmissions within the same time-frequency resource (subframe and subchannel), as long as their mutual interference is guaranteed to be negligible.

In particular, the requirement for low interference (as well as for low access delay) is very important for the provision of services which require Ultra-Reliable Low-Latency Communications (URLLC), such as V2V services for cooperative autonomous driving (e.g., cooperative sensing or cooperative maneuvers).

In order to proactively determine whether the mutual interference among multiple PSSCH transmissions may be negligible, before such transmissions are allowed to use the same time-frequency resource, or equivalently, in order to ensure a high Signal-to-Interference-plus-Noise Ratio (SINR), current solutions exploit the knowledge of the UE's geographic location (e.g., obtained via GPS and reported periodically by the UE to the network). The reuse of a time-frequency resource is then possible whenever terminals are sufficiently far apart. This is equivalent to imposing a minimum reuse distance.

However, such location-based reuse strategies have the disadvantage that they do not take into account the actual physical propagation of waves (i.e., the wireless channel). For example, whereas two vehicles on the highway may need to be ˜1 km away to transmit on the same resource with negligible interference, the situation may be very different in an urban environment where buildings shield most of the interference between nearby streets. Furthermore, location-based reuse does not take advantage of directional antennas, which may be deployed in future vehicles.

As a result, such approaches may only be able to satisfy the high SINR requirements by reusing resources in a rather conservative way, namely by allowing transmissions to use the same radio resource only if the UEs are located very far away. This leads to lower spectral efficiency of the cellular system. Another disadvantage of location-based reuse is that it requires a centralized entity that collects the positions of all UEs within a certain area (such as a cell). Thus, it is not applicable when out of coverage.

For out-of-coverage operation, the current 3GPP specifications for V2X sidelink communication specify a UE autonomous resource selection procedure which excludes certain resources based on sensing the wireless channel, in particular through the introduction of two key measurements: PSSCH-RSRP (PSSCH Reference Signal Received Power) and S-RSSI (Sidelink Received Signal Strength Indicator). However, sensing is performed at the transmitter, not the receiver, leading to the well-known hidden terminal problem. Moreover, the resource selection procedure does not take into account the impact of the eventual transmission on nearby receivers.

Thus, there is a need for improved wireless communication devices and methods for communication in a wireless communication network, in particular in a V2V communication network.

### SUMMARY

It is an objective of the invention to provide for improved wireless communication devices and methods for communication in a wireless communication network, in particular in a V2V communication network.

The foregoing and other objectives are achieved by the subject matter of the independent claims. Further implementation forms are apparent from the dependent claims, the description and the figures.

According to a first aspect, the invention relates to a wireless communication device (j) for communication in a wireless communication network supporting a plurality of sidelink radio resources, wherein the wireless communication device (j) comprises a transceiver configured to measure a first signal strength parameter (PO, in particular a Physical Sidelink Shared Channel (PSSCH) Reference Signal Received Power (RSRP), associated with at least one neighboring wireless communication device (i), and/or measure a second signal strength parameter (Iⱼ(s)), in particular a Sidelink Received Signal Strength Indicator (S-RSSI), associated with at least one of the plurality of sidelink radio resources (s). Moreover, the wireless communication device (j) comprises a processor configured to determine an interference-related parameter (Hⱼ(s)), in particular a PSSCH Interference Headroom, associated with at least one of the plurality of sidelink radio resources (s), compute a first map (Sⱼ) mapping an identity-related parameter (IDᵢ) of the at least one neighboring wireless communication device (i) to Pᵢⱼ or a function thereof, and/or compute a second map (Cⱼ) mapping at least one sidelink radio resource (s) to Iⱼ(s) or Hⱼ(s) or a function thereof. Furthermore, the transceiver is configured to transmit Sⱼ and/or Cⱼ to a network entity, in particular a base station, and/or to at least one neighboring wireless communication device.

Thus, an improved wireless communication device j is provided.

In a first possible implementation form of the wireless communication device (j) according to the first aspect as such, the plurality of sidelink radio resources (s) are arranged in a superframe, in particular of a physical shared channel, that comprises semi-persistent allocations of the wireless communication devices.

In a second possible implementation form of the wireless communication device (j) according to the first aspect as such or the first implementation form thereof, the transceiver is further configured to transmit to the at least one neighboring wireless communication device (i) a set (Tⱼ) of transmitting sidelink radio resources and/or a set (Rⱼ) of receiving sidelink radio resources of the wireless communication device (j).

In a third possible implementation form of the wireless communication device (j) according to the first aspect as such or any one of the implementation forms thereof, the identity-related parameter (IDᵢ) of the at least one neighboring wireless communication device (i) is indicated, in particular, by a resource indication value corresponding to the location, in time and/or frequency, of a recent transmission from wireless communication device (i) to wireless communication device (j), or a function thereof.

In a fourth possible implementation form of the wireless communication device (j) according to the first aspect as such or any one of the first to third implementation forms thereof, the function of Pᵢⱼ in the first map (Sⱼ) is a quantization of Pᵢⱼ.

In a fifth possible implementation form of the wireless communication device (j) according to the first aspect as such or any one of the first to fourth implementation forms thereof, the function of Iⱼ(s) or Hⱼ(s) in the second map (Cⱼ) is a quantization of Iⱼ(s) or Hⱼ(s).

In a sixth possible implementation form of the wireless communication device (j) according to the fourth implementation form of the first aspect, the processor is further configured to set the value of Cⱼ(s) to Hⱼ(s) or a function thereof, if the sidelink radio resource (s) is part of the set Rⱼ, and/or set the value of Cⱼ(s) to Iⱼ(s) or a function thereof, if the sidelink radio resource (s) is not part of the set Rⱼ.

In a seventh possible implementation form of the wireless communication device (j) according to the sixth implementation form of the first aspect, the function of Hⱼ(s) and/or Iⱼ(s) is based on the quantization of Pᵢⱼ.

In an eighth possible implementation form of the wireless communication device (j) according to the first aspect as such or any one of the first to seventh implementation forms thereof, the transceiver is further configured to transmit only changes in Sⱼ and/or Cⱼ, relative to an earlier update.

According to a second aspect, the invention relates to a wireless communication device (i) for communication in a wireless communication network supporting a plurality of sidelink radio resources, wherein the wireless communication device (i) comprises a transceiver configured to receive, from at least one neighboring wireless communication device (j), a first map (Sⱼ) mapping an identity-related parameter (IDᵢ) of the wireless communication device (i) to a first signal strength parameter (Pᵢⱼ), in particular a Physical Sidelink Shared Channel (PSSCH) Reference Signal Received Power (RSRP), or a function thereof, and/or a second map (Cⱼ) mapping at least one sidelink radio resource (s) to a second signal strength parameter (Iⱼ(s)), in particular a Sidelink Received Signal Strength Indicator (S-RSSI), or an interference-related parameter (Hⱼ(s)), in particular a PSSCH Interference Headroom, or a function thereof. Furthermore, the transceiver is configured to receive, from the at least one neighboring wireless communication device (j), a set (Tⱼ) of transmitting sidelink radio resources and/or a set (Rⱼ) of receiving sidelink radio resources of the wireless communication device (j). Moreover, the wireless communication device (i) comprises a processor configured to select one or more sidelink radio resources (s) from the plurality of sidelink radio resources for communicating with the neighboring wireless communication device (j), or with another wireless communication device (j), in particular on the basis of a comparison between Sⱼ(i) and Cⱼ(s).

Thus, an improved wireless communication device i is provided.

In a first possible implementation form of the wireless communication device (i) according to the second aspect as such, the processor is further configured to select one or more sidelink radio resources (s) from the plurality of sidelink radio resources for communicating with at least one neighboring wireless communication device (j), in particular on the basis of the relative motion, in particular relative velocity, of the transmitting wireless communication device (i) and/or the at least one receiving wireless communication device (j), with respect to the wireless communication devices already transmitting and/or receiving in the sidelink radio resource (s).

According to a third aspect, the invention relates to a network entity, in particular a base station, for communication in a wireless communication network supporting a plurality of sidelink radio resources, wherein the communication network comprises a plurality of wireless communication devices, wherein the network entity comprises a transceiver configured to receive, from a wireless communication device (j) of the plurality of wireless communication devices, a first map (Sⱼ) mapping an identity-related parameter (IDᵢ) of at least one neighboring wireless communication device (i) of the wireless communication device (j) to a first signal strength parameter (Pᵢⱼ), in particular a Physical Sidelink Shared Channel (PSSCH) Reference Signal Received Power (RSRP), or a function thereof, and/or a second map (Cⱼ) mapping at least one sidelink radio resource (s) to a second signal strength parameter (Iⱼ(s)), in particular a Sidelink Received Signal Strength Indicator (S-RSSI), or an interference-related parameter (Hⱼ(s)), in particular a PSSCH Interference Headroom, or a function thereof. Moreover, the network entity comprises a processor configured to select one or more sidelink radio resources (s) from the plurality of sidelink radio resources for communication between the at least one neighboring wireless communication device (i) and the wireless communication device (j), or another wireless communication device (l), in particular on the basis of a comparison between Sⱼ(i) and Cⱼ(s).

Thus, an improved network entity is provided.

In a first possible implementation form of the network entity according to the third aspect as such, the processor is further configured to select one or more sidelink radio resources (s) from the plurality of sidelink radio resources for communication between a wireless communication device (i) and at least one neighboring wireless communication device (j), in particular on the basis of the relative motion, in particular relative velocity, of the transmitting wireless communication device (i) and/or the at least one receiving wireless communication device (j), with respect to the wireless communication devices already transmitting and/or receiving in the sidelink radio resource (s).

According to a fourth aspect, the invention relates to a method for communication in a wireless communication network supporting a plurality of sidelink radio resources, wherein the method comprises the steps of measuring a first signal strength parameter (PO, in particular a Physical Sidelink Shared Channel (PSSCH) Reference Signal Received Power (RSRP), associated with at least one neighboring wireless communication device (i), and/or measuring a second signal strength parameter (Iⱼ(s)), in particular a Sidelink Received Signal Strength Indicator (S-RSSI), associated with at least one of the plurality of sidelink radio resources (s), and determining an interference-related parameter (Hⱼ(s)), in particular a PSSCH Interference Headroom, associated with at least one of the plurality of sidelink radio resources (s), computing a first map (Sⱼ) mapping an identity-related parameter (IDᵢ) of the at least one neighboring wireless communication device (i) to Pᵢⱼ or a function thereof, and/or computing a second map (Cⱼ) mapping at least one sidelink radio resource (s) to Iⱼ(s) or Hⱼ (s) or a function thereof, and transmitting Sⱼ and/or Cⱼ to a network entity, in particular a base station, and/or to at least one neighboring wireless communication device.

Thus, an improved method is provided.

In a first possible implementation form of the method according to the fourth aspect as such, the method further comprises the step of transmitting to the at least one neighboring wireless communication device (i) a set (Tⱼ) of transmitting sidelink radio resources and/or a set (Rⱼ) of receiving sidelink radio resources of the wireless communication device (j).

According to a fifth aspect, the invention relates to a method for communication in a wireless communication network supporting a plurality of sidelink radio resources, wherein the method comprises the steps of receiving, from at least one neighboring wireless communication device (j), a first map (Sⱼ) mapping an identity-related parameter (IDᵢ) of the wireless communication device (i) to a first signal strength parameter (Pᵢⱼ), in particular a Physical Sidelink Shared Channel (PSSCH) Reference Signal Received Power (RSRP), or a function thereof, and/or a second map (Cⱼ) mapping at least one sidelink radio resource (s) to a second signal strength parameter (Iⱼ(s)), in particular a Sidelink Received Signal Strength Indicator (S-RSSI), or an interference-related parameter (Hⱼ(s)), in particular a PSSCH Interference Headroom, or a function thereof, receiving, from the at least one neighboring wireless communication device (j), a set (Tⱼ) of transmitting sidelink radio resources and/or a set (Rⱼ) of receiving sidelink radio resources of the wireless communication device (j), selecting one or more sidelink radio resources (s) from the plurality of sidelink radio resources for communicating with the neighboring wireless communication device (j), or with another wireless communication device (l), in particular on the basis of a comparison between Sⱼ(i) and Cⱼ(s), and/or selecting one or more sidelink radio resources (s) from the plurality of sidelink radio resources for communicating with at least one neighboring wireless communication device (j), in particular on the basis of the relative motion, in particular relative velocity, of the transmitting wireless communication device (i) and/or the at least one receiving wireless communication device (j), with respect to the wireless communication devices already transmitting and/or receiving in the sidelink radio resource (s).

Thus, an improved method is provided.

According to a sixth aspect, the invention relates to a method for communication in a wireless communication network supporting a plurality of sidelink radio resources, wherein the communication network comprises a network entity, in particular a base station, as well as a plurality of wireless communication devices, wherein the method comprises the steps of receiving at the network entity, from a wireless communication device (j) of the plurality of wireless communication devices, a first map (Sⱼ) mapping an identity-related parameter (IDᵢ) of at least one neighboring wireless communication device (i) of the wireless communication device (j) to a first signal strength parameter (Pᵢⱼ), in particular a Physical Sidelink Shared Channel (PSSCH) Reference Signal Received Power (RSRP), or a function thereof, and/or a second map (Cⱼ) mapping at least one sidelink radio resource (s) to a second signal strength parameter (Iⱼ(s)), in particular a Sidelink Received Signal Strength Indicator (S-RSSI), or an interference-related parameter (Hⱼ(s)), in particular a PSSCH Interference Headroom, or a function thereof, the network entity selecting one or more sidelink radio resources (s) from the plurality of sidelink radio resources for communication between the at least one neighboring wireless communication device (i) and the wireless communication device (j), or another wireless communication device (l), in particular on the basis of a comparison between Sⱼ(i) and Cⱼ(s), and/or the network entity selecting one or more sidelink radio resources (s) from the plurality of sidelink radio resources for communication between a wireless communication device (i) and at least one neighboring wireless communication device (j), in particular on the basis of the relative motion, in particular relative velocity, of the transmitting wireless communication device (i) and/or the at least one receiving wireless communication device (j), with respect to the wireless communication devices already transmitting and/or receiving in the sidelink radio resource (s).

Thus, an improved method is provided.

According to a seventh aspect, the invention relates to a computer program comprising a program code for performing the method of the fourth aspect or the first implementation form thereof, the method of the fifth aspect or the method of the sixth aspect when executed on a computer.

The invention can be implemented in hardware and/or software.

### BRIEF DESCRIPTION OF THE DRAWINGS

Further embodiments of the invention will be described with respect to the following figures, wherein:

FIG. 1 shows a schematic diagram of a wireless communication network comprising two wireless communication devices according to an embodiment and a network entity according to an embodiment;

FIG. 2 shows a schematic diagram illustrating an example of a Physical Sidelink Shared Channel (PSSCH) superframe for communication in a wireless communication network according to an embodiment;

FIG. 3 shows a schematic diagram illustrating an exemplary set Nⱼ of neighboring wireless communication devices of a wireless communication device j in a wireless communication network, and threshold values Pₘ, according to an embodiment;

FIG. 4 shows a schematic diagram illustrating an exemplary first map Sⱼ and an exemplary second map Cⱼ computed by a wireless communication device j according to an embodiment;

FIG. 5 shows a logical flow diagram of a method for communication in a wireless communication network according to an embodiment;

FIG. 6 shows a logical flow diagram of a method for communication in a wireless communication network according to an embodiment; and

FIG. 7 shows a logical flow diagram of a method for communication in a wireless communication network according to an embodiment.

In the various figures, identical reference signs will be used for identical or at least functionally equivalent features.

### DETAILED DESCRIPTION OF EMBODIMENTS

In the following description, reference is made to the accompanying drawings, which form part of the disclosure, and in which are shown, by way of illustration, specific aspects in which the present invention may be placed. It is understood that other aspects may be utilized and structural or logical changes may be made without departing from the scope of the present invention. The following detailed description, therefore, is not to be taken in a limiting sense, as the scope of the present invention is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

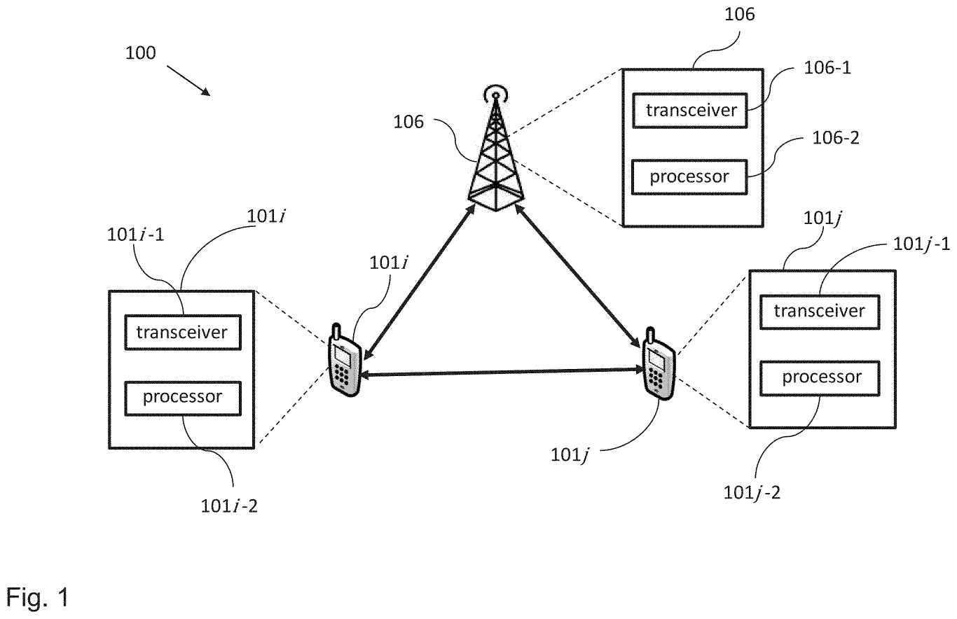

FIG. 1 shows a schematic diagram of a wireless communication network 100 comprising two wireless communication devices 101i and 101j according to an embodiment, and a network entity 106 according to an embodiment.

In an embodiment, the wireless communication network 100 is a mobile or cellular communication network.

In an embodiment, the network entity 106 is a base station, and the wireless communication devices 101i and 101j are User Equipments (UEs), in particular communication units of a vehicle. For the sake of clarity, the wireless communication devices 101i and 101j will also be referred to simply as wireless communication devices i and j.

The wireless communication device 101j comprises a transceiver 101j-1 configured to measure a first signal strength parameter (Pᵢⱼ), in particular a Physical Sidelink Shared Channel (PSSCH) Reference Signal Received Power (RSRP), associated with at least one neighboring wireless communication device 101i, and/or measure a second signal strength parameter (Iⱼ(s)), in particular a Sidelink Received Signal Strength Indicator (S-RSSI), associated with at least one of the plurality of sidelink radio resources (s). Moreover, the wireless communication device 101j comprises a processor 101j-2 configured to determine an interference-related parameter (Hⱼ(s)), in particular a PSSCH Interference Headroom, associated with at least one of the plurality of sidelink radio resources (s), compute a first map (Sᵢ) mapping an identity-related parameter (IDᵢ) of the at least one neighboring wireless communication device 101i to Pᵢⱼ or a function thereof, and/or compute a second map (Cⱼ) mapping at least one sidelink radio resource (s) to Iⱼ(s) or Hⱼ(s) or a function thereof. Furthermore, the transceiver 101j-1 is configured to transmit Sⱼ and/or Cⱼ to a network entity 106, in particular a base station, and/or to at least one neighboring wireless communication device.

The wireless communication device 101i comprises a transceiver 101j-1 configured to receive, via the wireless communication channel, from the neighboring wireless communication device 101j, the first map (Sⱼ) mapping the identity-related parameter (IDᵢ) of the wireless communication device 101i to the first signal strength parameter (Pᵢⱼ), in particular a Physical Sidelink Shared Channel (PSSCH) Reference Signal Received Power (RSRP), or a function thereof, and/or the second map (Cⱼ) mapping at least one sidelink radio resource (s) to the second signal strength parameter IIⱼ(s)), in particular a Sidelink Received Signal Strength Indicator (S-RSSI), or the interference-related parameter (Hᵢ (s)), in particular a PSSCH Interference Headroom, or a function thereof. Moreover, the transceiver 101j-1 of the wireless communication device 101i can be configured to receive, from the neighboring wireless communication device 101j, a set (Tⱼ) of transmitting sidelink radio resources and/or a set (Rⱼ) of receiving sidelink radio resources of the wireless communication device 101j. Furthermore, the wireless communication device 101i can comprise a processor 101i-2 configured to select one or more sidelink radio resources (s) from the plurality of sidelink radio resources for communicating with the neighboring wireless communication device 101j, or with another wireless communication device (l), in particular on the basis of a comparison between Sⱼ(i) and Cⱼ(s).

The network entity 106, in particular a base station, supports a plurality of sidelink radio resources. Moreover, the network entity 106 can comprise a transceiver 106-1 configured to receive, from the wireless communication device 101j, the first map (Sⱼ) mapping an identity-related parameter (IDᵢ) of the wireless communication device 101i to the first signal strength parameter (Pᵢⱼ), in particular a Physical Sidelink Shared Channel (PSSCH) Reference Signal Received Power (RSRP), or a function thereof, and/or the second map (Cⱼ) mapping at least one sidelink radio resource (s) to the second signal strength parameter (Iⱼ(s)), in particular a Sidelink Received Signal Strength Indicator (S-RSSI), or the interference-related parameter (Hⱼ(s)), in particular a PSSCH Interference Headroom, or a function thereof.

Moreover, the network entity 106 can comprise a processor 106-2 configured to select one or more sidelink radio resources (s) from the plurality of sidelink radio resources for communication between the wireless communication device 101i and the wireless communication device 101j, or another wireless communication device (l), in particular on the basis of a comparison between Sⱼ(i) and Cⱼ(s).

For example, the processor 106-2 of the network entity 106, when considering candidate resources (s) for transmission from wireless communication device 101i to at least one neighboring wireless communication device 101j, is configured to exclude (i.e., to not allocate) those resources (s) for which either Sⱼ(i)<Cⱼ(s) (or, equivalently, Pᵢⱼ<γlⱼ(s)) for any receiving wireless communication device 101j, namely, the wireless communication device 101i is too “far” (in terms of RF power) from at least one receiving wireless communication device 101j to achieve a predetermined target SINR γ, or Sₗ(i)>Cₗ(s) (or, equivalently, Pᵢₗ>Hₗ(s)) for any other neighboring wireless communication device (l) already receiving in resource s, namely, the wireless communication device 101i is too “close” (in terms of RF power) to at least one other neighboring wireless communication device (l) already receiving in resource s.

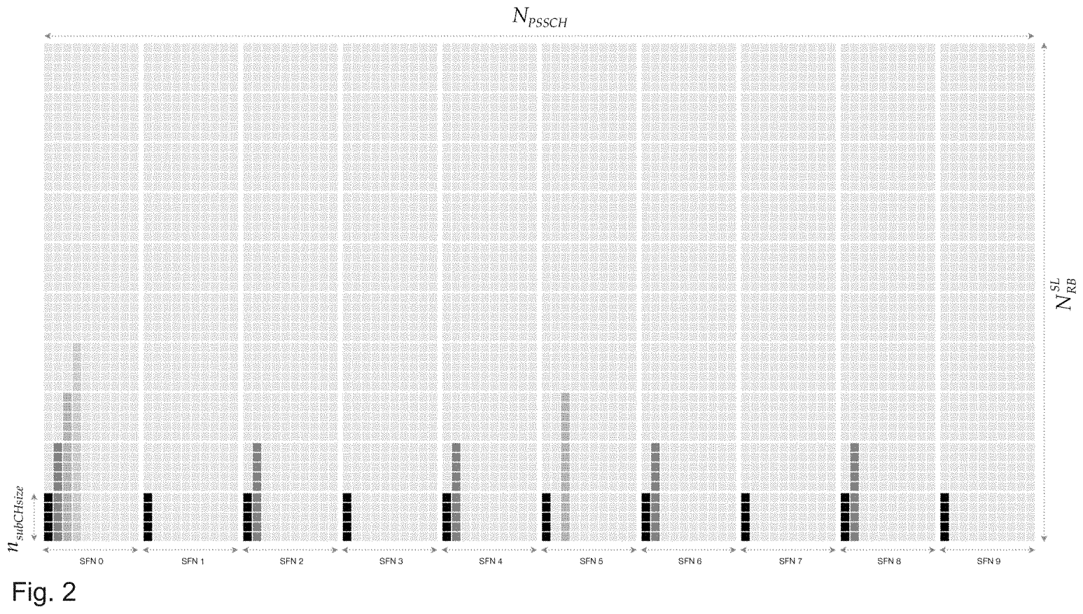

In embodiments of the invention, in the scheduled mode, which will be described in more detail in the context of FIG. 2, the Sidelink Shared Channel (SL-SCH) scheduler is located in the base station 106 (or any other network entity responsible for granting the rights to transmit on PSSCH), and in the autonomous mode, the SL-SCH scheduler is located in the wireless communication device 101i.

In embodiments of the invention, the plurality of sidelink radio sources are arranged in a Physical Sidelink Shared Channel (PSSCH) superframe, and comprise the set of transmitting resources Tⱼ, i.e., a set of resources via which the wireless communication device 101j is scheduled to transmit within each PSSCH superframe, and the set of receiving resources Rⱼ, i.e., a set of resources via which the wireless communication device 101j is scheduled to receive within each PSSCH superframe, as it will be better elucidated in the description of FIG. 2.

In embodiments of the invention, the identity-related parameter IDᵢ of the at least one neighboring wireless communication device 101i is indicated, in particular, by a resource indication value corresponding to the location, in time and/or frequency, of a recent transmission from wireless communication device 101i to wireless communication device 101j, or a function thereof.

In embodiments of the invention, the first signal strength parameter Pᵢⱼ[W] is defined as PSSCH Reference Signal Received Power (PSSCH-RSRP) in 3GPP TS 36.214,“Evolved Universal Terrestrial Radio Access (E-UTRA); Physical layer; Measurements (Release 14)”, September 2016, V14.0.0. For example, in case the wireless communication device 101j is a communication unit of a vehicle, the first signal strength parameter Pᵢⱼ can be obtained by measuring the received power of PSSCH Demodulation Reference Signals (DMRS) associated with periodic Cooperative Awareness Message (CAM) or Basic Safety Message (BSM) transmissions occurring, e.g., every 100 ms.

In an embodiment, for each resource s∈Rⱼ within the PSSCH superframe, the PSSCH Interference Headroom Hⱼ(s) [W] is defined as the maximum additional interference beyond which a target SINR γ would no longer be satisfied for the wireless communication device 101j receiving in resource s. In an embodiment, γ is a parameter configurable by the wireless communication network 100, which denotes the minimum SINR that should be guaranteed at any receiving wireless communication device.

In an embodiment, the second signal strength parameter Iⱼ(s) [W] is defined as Sidelink Received Signal Strength Indicator (S-RSSI) in 3GPP TS 36.214, “Evolved Universal Terrestrial Radio Access (E-UTRA); Physical layer; Measurements (Release 14)”, September 2016, V14.0.0, wherein for each resource s∉Rⱼ within the PSSCH superframe (excluding subframes in which the wireless communication device 101j is scheduled to transmit), the second signal strength parameter Iⱼ(s) is the observed power (including thermal noise power) in resource s.

FIG. 2 shows an example of a Physical Sidelink Shared Channel (PSSCH) superframe for communication in the wireless communication network 100 according to an embodiment.

In this example, a repeating (i.e., periodic) PSSCH transmit schedule for V2X sidelink communication is shown, which is referred to as PSSCH superframe. More specifically, FIG. 2 shows an example of a PSSCH superframe for a typical V2X traffic scenario, with a repeating pattern of length N_{PSSCH}=100 subframes (100 ms) and different traffic types with periodicities of 10, 20, 50 and 100 subframes. The sidelink system bandwidth consisting of N_{RB}^{SL}=50 Physical Resource Blocks (PRBs) is divided into N_{subCH}=N_{RB}^{SL}/n_{subCHsize} subchannels. The subchannel size n_{subCHsize} defines the granularity used for PSSCH resource allocation. A subchannel consists of n_{subCHsize} contiguous PRBs. The k-th subchannel consists of PRBs k n_{subCHsize} to (k+1)n_{subCHsize}−1, with k=0, . . . , N_{subCH}−1.

For the purpose of PSSCH resource allocation, a radio resource s is defined as a subframe/subchannel pair (t(s), f (s)), corresponding to a specific subframe t(s), with 0≤t(s)<N_{PSSCH}, and a specific subchannel f(s), with 0≤f(s)<N_{subCH}, within each repeating PSSCH superframe of size N_{PSSCH}×N_{subCH}.

In embodiments of the invention, the communication between the wireless communication devices in the wireless communication network 100 is periodic. This has the advantage that recent physical (PHY) layer measurements (e.g., S-RSSI in a given resource) can be used for allocating PSSCH resources in such a way that SINR requirements are satisfied.

Moreover, in order to prevent collisions on the Physical Sidelink Shared Channel (PSSCH) (i.e., the physical channel carrying the Sidelink Shared Channel (SL-SCH)), in embodiments of the invention, the following two MAC (Medium Access Control) constraints are taken into account when allocating sidelink resources:
(a) a wireless communication device cannot both transmit and receive in the same subframe (commonly known as half-duplex constraint), as it would interfere with itself This is due to the fact that every wireless communication device transmits PSSCH on the same carrier frequency within a given cell;
(b) the mutual interference among different PSSCH transmissions occurring in any given resource should be kept within acceptable levels.

In embodiments of the invention, in the scheduled mode, the half-duplex constraint (a) is straightforward to satisfy, since the SL-SCH scheduler at the base station (or any other network entity, e.g., the network entity 106, responsible for granting the rights to transmit on PSSCH) knows which wireless communication devices are transmitting/receiving in any given resource.

In order to satisfy (a) in autonomous mode, in embodiments of the invention, every wireless communication device, e.g., the wireless communication device 101j, periodically broadcast its PSSCH schedule (i.e., resources in which it is scheduled to transmit/receive), so that the neighboring wireless communication devices can select resources in which the wireless communication device 101j is not transmitting or receiving.

In embodiments of the invention, in order to satisfy the interference constraint (b), each wireless communication device, e.g., the wireless communication device 101j, transmits information to the network entity 106 (scheduled mode) and/or to its neighboring wireless communication devices (autonomous mode) about which wireless communication devices are in the “proximity” (in terms of RF power) of the wireless communication device 101j and how “close” (in terms of RF power) they are to the wireless communication device 101j. Moreover, for each resource in which the wireless communication device 101j is scheduled to receive, the transceiver 101j-1 of the wireless communication device 101j can be configured to transmit information about how “close” (in terms of RF power) a neighboring wireless communication device can be allowed to transmit without degrading reception at the wireless communication device 101j, and, for each other resource, how “far” (in terms of RF power) a wireless communication device can be and still be able to reliably communicate with the wireless communication device 101j.

In scheduled mode, the wireless communication device 101j periodically reports the aforementioned information to the network entity 106, while, in autonomous mode, the wireless communication device 101j periodically broadcasts the aforementioned information to its neighboring wireless communication devices.

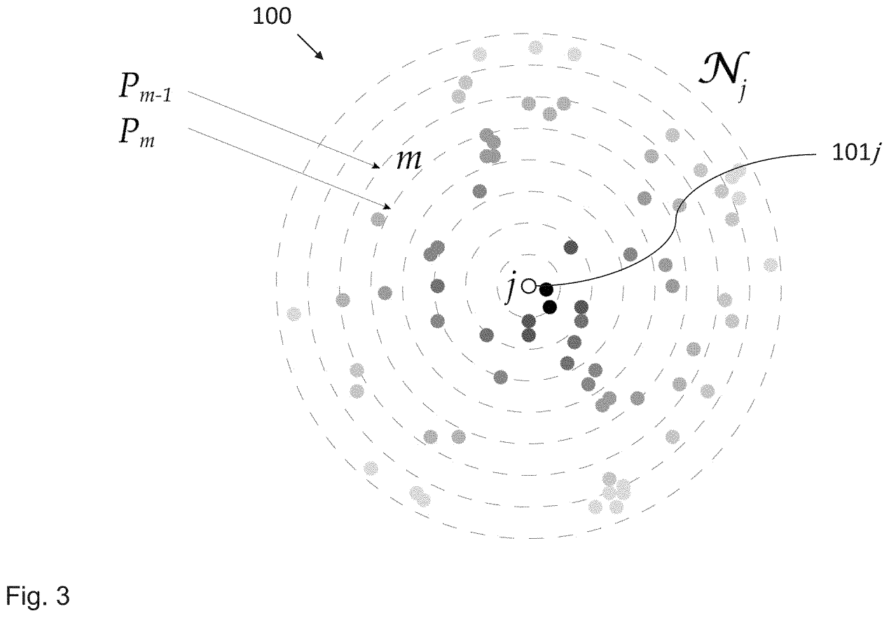

FIG. 3 shows a schematic diagram illustrating an exemplary set Nⱼ of neighboring wireless communication devices of a wireless communication device j in the wireless communication network 100, and threshold values Pₘ, according to an embodiment.

The plurality of neighboring wireless communication devices comprise the wireless communication device 101j. The processor 101j-2 of the wireless communication device 101j can be configured to perform the following steps:

1st step: determining the set Nⱼ comprising identity-related parameters IDᵢ of neighboring wireless communication devices, e.g., of the wireless communication device 101i, satisfying the condition Pᵢⱼ>γ_{C}, with γ_{C} being a parameter configurable by the wireless communication network 100;

2nd step: mapping, by means of the first map Sⱼ, the identity-related parameter IDᵢ of each neighboring wireless communication device i, i∈Nⱼ, or a subset thereof, to the measured RSRP value Pᵢⱼ (indicated by setting Sⱼ(i)=Pᵢⱼ), or to one of nₛ RSRP value ranges, specified by a set of predetermined threshold values Pₘ, 0≤m≤nₛ, with Pₘ₋₁<Pₘ. In particular, a neighboring wireless communication device 101i is mapped to RSRP value range m (indicated by setting Sⱼ(i)=m) if and only if

Pₘ₋₁<Pᵢⱼ<Pₘ.

3rd step: mapping, by means of the second map Cⱼ, each resource s within the PSSCH superframe (excluding subframes in which the wireless communication device 101j is scheduled to transmit), or a subset thereof, to a value Cⱼ(s) as follows:

if s∈Rⱼ, Cⱼ(s) is set to Hⱼ(s) or to the highest index m for which Pₘ<Hⱼ(s)

if s∉Rⱼ, Cⱼ(s) is set to γIⱼ(s) or to the lowest index m for which Pₘ₋₁>γIⱼ(s),

where γ is the minimum SINR that should be guaranteed for the communication link.

In embodiments of the invention, the wireless communication device 101j periodically (e.g., every 100 ms) reports to the network entity 106 (scheduled mode), or broadcasts to its neighboring wireless communication devices (autonomous mode), the first map Sⱼ and the second map Cⱼ.

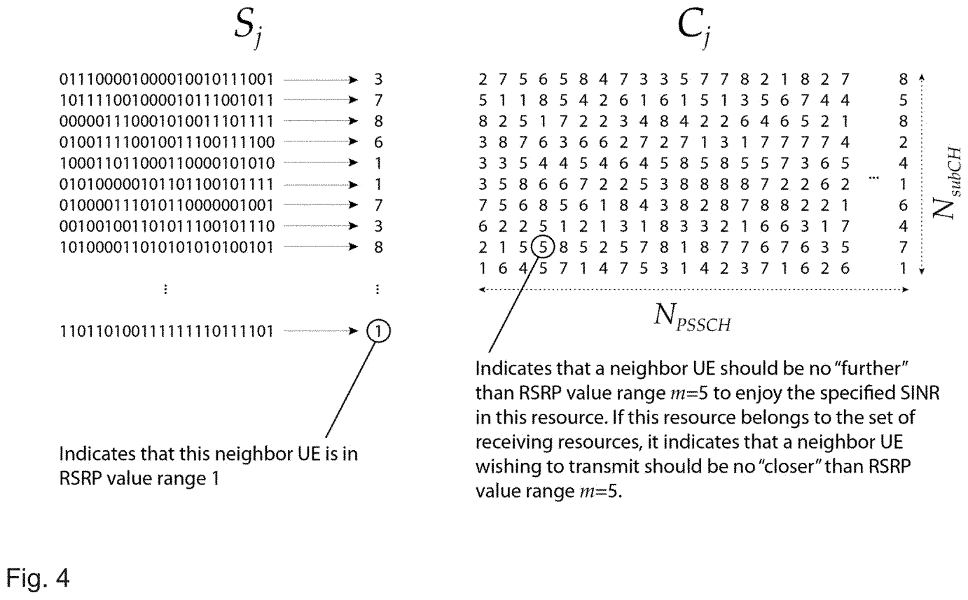

An example of the first map Sⱼ and the second map Cⱼ of the wireless communication device 101j according to embodiments of the invention is shown in FIG. 4.

In embodiments of the invention, in the autonomous mode, the broadcast comprises also the PSSCH schedule (i.e., the set of transmitting resources Tⱼ and the set of receiving resources Rⱼ) of the wireless communication device 101j.

In embodiments of the invention, in order to minimize signaling overhead, the transceiver 101j-1 of the wireless communication device 101j can be configured to only transmit the changes in the first map Sⱼ and in the second map Cⱼ relative to an earlier update. The full maps can be transmitted at a lower update rate (e.g., with every 10th update).

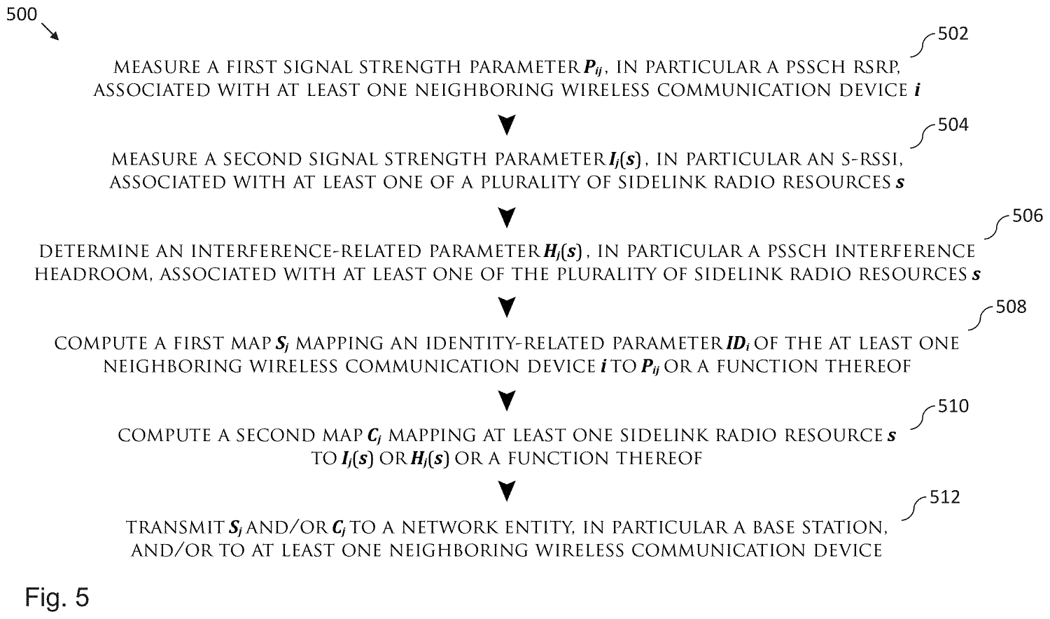

FIG. 5 shows a logical flow diagram of a method 500 for communication in the wireless communication network 100 supporting a plurality of sidelink radio resources according to an embodiment.

The method 500 comprises the steps of measuring 502 a first signal strength parameter (Pᵢⱼ), in particular a Physical Sidelink Shared Channel (PSSCH) Reference Signal Received Power (RSRP), associated with at least one neighboring wireless communication device 101i, and/or measuring 504 a second signal strength parameter (Iⱼ(s)), in particular a Sidelink Received Signal Strength Indicator (S-RSSI), associated with at least one of the plurality of sidelink radio resources (s), and determining 506 an interference-related parameter (Hⱼ(s)), in particular a PSSCH Interference Headroom, associated with at least one of the plurality of sidelink radio resources (s), computing 508 a first map (Sⱼ) mapping an identity-related parameter (IDᵢ) of the at least one neighboring wireless communication device 101i to Pᵢⱼ or a function thereof, and/or computing 510 a second map (Cⱼ) mapping at least one sidelink radio resource (s) to Iⱼ(s) or Hⱼ(s) or a function thereof, and transmitting 512 Sⱼ and/or Cⱼ to a network entity 106, in particular a base station, and/or to at least one neighboring wireless communication device.

The method 500 can be performed by the wireless communication device 101j described above. Further features of the method 500 result directly from the functionality of the wireless communication device 101j and its different embodiments.

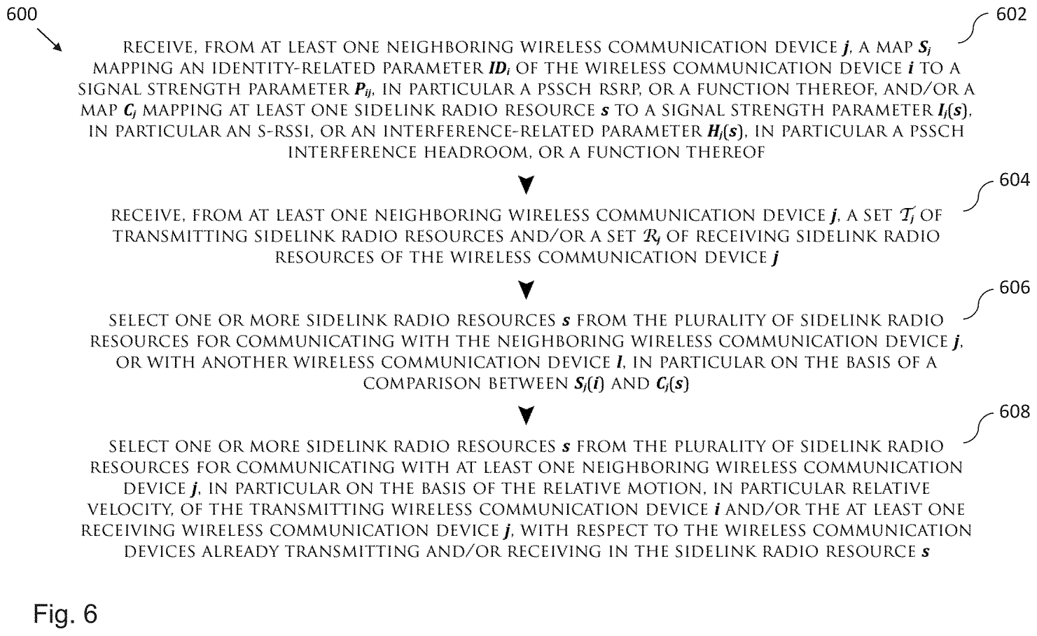

FIG. 6 shows a logical flow diagram of a method 600 for communication in the wireless communication network 100 supporting a plurality of sidelink radio resources according to an embodiment.

The method 600 comprises the steps of receiving 602, from at least one neighboring wireless communication device 101j, a first map (Sⱼ) mapping an identity-related parameter (IDᵢ) of the wireless communication device 101i to a first signal strength parameter (Pᵢⱼ), in particular a Physical Sidelink Shared Channel (PSSCH) Reference Signal Received Power (RSRP), or a function thereof, and/or a second map (Cⱼ) mapping at least one sidelink radio resource (s) to a second signal strength parameter (Iⱼ(s)), in particular a Sidelink Received Signal Strength Indicator (S-RSSI), or an interference-related parameter (Hⱼ(s)), in particular a PSSCH Interference Headroom, or a function thereof, receiving 604, from the at least one neighboring wireless communication device 101j, a set (Tⱼ) of transmitting sidelink radio resources and/or a set (Rⱼ) of receiving sidelink radio resources of the wireless communication device 101j, selecting 606 one or more sidelink radio resources (s) from the plurality of sidelink radio resources for communicating with the neighboring wireless communication device 101j, or with another wireless communication device (l), in particular on the basis of a comparison between Sⱼ(i) and Cⱼ(s), and/or selecting 608 one or more sidelink radio resources (s) from the plurality of sidelink radio resources for communicating with at least one neighboring wireless communication device 101j, in particular on the basis of the relative motion, in particular relative velocity, of the transmitting wireless communication device 101i and/or the at least one receiving wireless communication device 101j, with respect to the wireless communication devices already transmitting and/or receiving in the sidelink radio resource (s). The relative motion, in particular relative velocity, can be derived from the content of periodic CAM or BSM messages received by the wireless communication device 101i from neighboring wireless communication devices.

The method 600 can be performed by the wireless communication device 101i described above. Further features of the method 600 result directly from the functionality of the wireless communication device 101i and its different embodiments.

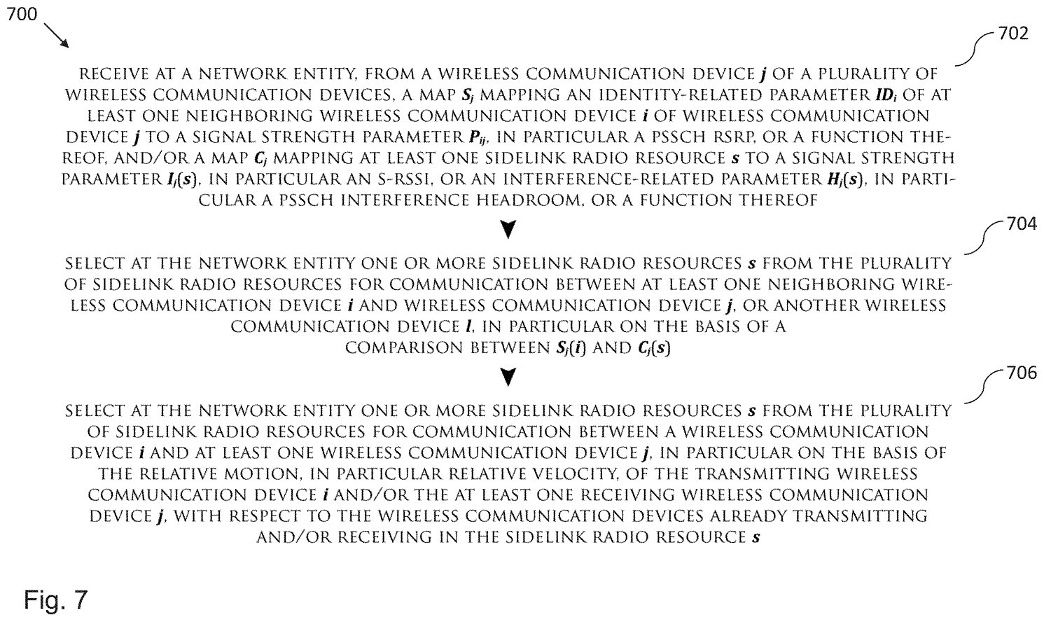

FIG. 7 shows a logical flow diagram of a method 700 for communication in the wireless communication network 100 supporting a plurality of sidelink radio resources.

The method 700 comprises the steps of receiving 702 at the network entity 106, from a wireless communication device 101j of the plurality of wireless communication devices, a first map (Sⱼ) mapping an identity-related parameter (IDᵢ) of the at least one neighboring wireless communication device 101i of the wireless communication device 101j to a first signal strength parameter (Pᵢⱼ), in particular a Physical Sidelink Shared Channel (PSSCH) Reference Signal Received Power (RSRP), or a function thereof, and/or a second map (Cⱼ) mapping at least one sidelink radio resource (s) to a second signal strength parameter (Iⱼ(s)), in particular a Sidelink Received Signal Strength Indicator (S-RSSI), or an interference-related parameter (Hⱼ(s)), in particular a PSSCH Interference Headroom, or a function thereof, selecting 704 by the network entity 106 one or more sidelink radio resources (s) from the plurality of sidelink radio resources for communication between the at least one neighboring wireless communication device 101i and the wireless communication device 101j, or another wireless communication device (l), in particular on the basis of a comparison between Sⱼ(i) and Cⱼ(s), and/or selecting 706 by the network entity 106 one or more sidelink radio resources (s) from the plurality of sidelink radio resources for communication between a wireless communication device 101i and at least one neighboring wireless communication device 101j, in particular on the basis of the relative motion, in particular relative velocity, of the transmitting wireless communication device 101i and/or the at least one receiving wireless communication device 101j, with respect to the wireless communication devices already transmitting and/or receiving in the sidelink radio resource (s). The relative motion, in particular relative velocity, can be derived from periodic position reports received by the network entity 106 from the wireless communication devices.

The method 700 can be performed by the network entity 106 described above. Further features of the method 700 result directly from the functionality of the network entity 106 and its different embodiments.

While a particular feature or aspect of the disclosure may have been disclosed with respect to only one of several implementations or embodiments, such a feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless of whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present invention has been described with reference to one or more particular embodiments, those skilled in the art recognize that many changes may be made thereto without departing from the scope of the present invention. It is therefore to be understood that within the scope of the appended claims and their equivalents, the invention may be practiced otherwise than as specifically described herein.

1. A wireless communication device for communication in a wireless communication network supporting a plurality of sidelink radio resources, wherein the wireless communication device comprises:
a transceiver, the transceiver configured to perform at least one of the following:
measure a first signal strength parameter (Pᵢⱼ) associated with at least one neighboring wireless communication device; or
measure a second signal strength parameter (Iⱼ(s)) associated with at least one of the plurality of sidelink radio resources (s); and
at least one processor, the at least one processor configured to:
determine an interference-related parameter (Hⱼ (s)) associated with at least one of the plurality of sidelink radio resources (s); and at least one of:
compute a first map (Sⱼ) mapping an identity-related parameter (IDᵢ) of the at least one neighboring wireless communication device to Pᵢⱼ; or
compute a second map (Cⱼ) mapping at least one sidelink radio resource (s) to Iⱼ(s) or Hⱼ(s); and
wherein the transceiver is further configured to transmit at least one of Sⱼ or Cⱼ to at least one of a network entity or at least one neighboring wireless communication device.

2. The wireless communication device of claim 1, wherein the plurality of sidelink radio resources (s) are arranged in a superframe that comprises semi-persistent allocations of the wireless communication devices.

3. The wireless communication device of claim 1, wherein the transceiver is further configured to transmit to the at least one neighboring wireless communication device at least one of a set (Tⱼ) of transmitting sidelink radio resources or a set (Rⱼ) of receiving sidelink radio resources of the wireless communication device.

4. The wireless communication device of claim 1, wherein the identity-related parameter (IDᵢ) of the at least one neighboring wireless communication device is indicated by a resource indication value corresponding to a location, in at least one of time or frequency, of a recent transmission from the at least one neighboring wireless communication device to the wireless communication device.

5. The wireless communication device of claim 1, wherein the function of Pᵢⱼ in the first map (Sⱼ) is a quantization of Pᵢⱼ.

6. The wireless communication device of claim 1, wherein the function of Iⱼ(s) or Hⱼ(s) in the second map (Cⱼ) is a quantization of Iⱼ(s) or Hⱼ(s).

7. The wireless communication device of claim 6, wherein the at least one of processor is further configured to set the value of Cⱼ(s) to:
Hⱼ(s), if the sidelink radio resource (s) is part of the set Rⱼ; or
Iⱼ(s), if the sidelink radio resource (s) is not part of the set Rⱼ.

8. The wireless communication device of claim 1, wherein the function of at least one of Hⱼ(s) or Iⱼ(s) is based on the quantization of Pᵢⱼ.

9. The wireless communication device of claim 1, wherein the transceiver is further configured to transmit only changes in at least one of Sⱼ or Cⱼ, relative to an earlier update.

10. A wireless communication device for communication in a wireless communication network supporting a plurality of sidelink radio resources, wherein the wireless communication device comprises:
a transceiver, the transceiver configured to receive, from at least one neighboring wireless communication device, at least one of:
a first map (Sⱼ) mapping an identity-related parameter (IDᵢ) of the wireless communication device to a first signal strength parameter (Pᵢⱼ); or
a second map (Cⱼ) mapping at least one sidelink radio resource (s) to a second signal strength parameter (Iⱼ(s)) or an interference-related parameter (Hⱼ(s));
the transceiver further configured to receive, from the at least one neighboring wireless communication device, at least one of a set (Tⱼ) of transmitting sidelink radio resources or a set (Rⱼ) of receiving sidelink radio resources of the wireless communication device; and
at least one processor, the at least one processor configured to select one or more sidelink radio resources (s) from the plurality of sidelink radio resources for communicating with the neighboring wireless communication device or with another wireless communication device on the basis of a comparison between Sⱼ(i) and Cⱼ(s).

11. The wireless communication device of claim 10, wherein the at least one processor is further configured to select one or more sidelink radio resources (s) from the plurality of sidelink radio resources for communicating with at least one neighboring wireless communication device on the basis of relative velocity of at least one of the transmitting wireless communication device or the at least one receiving wireless communication device, with respect to wireless communication devices already at least one of transmitting or receiving in the sidelink radio resource (s).

12. A network entity for communication in a wireless communication network supporting a plurality of sidelink radio resources, wherein the communication network comprises a plurality of wireless communication devices, and wherein the network entity comprises:
a transceiver, the transceiver configured to receive, from a wireless communication device of the plurality of wireless communication devices, at least one of:
a first map (Sⱼ) mapping an identity-related parameter (IDᵢ) of at least one neighboring wireless communication device of the wireless communication device to a first signal strength parameter (Pᵢⱼ); or
a second map (Cⱼ) mapping at least one sidelink radio resource (s) to a second signal strength parameter (Iⱼ(s)) or an interference-related parameter (Hⱼ(s)); and
at least one processor, the at least one processor configured to select one or more sidelink radio resources (s) from the plurality of sidelink radio resources for communication between the at least one neighboring wireless communication device and the wireless communication device or another wireless communication device on the basis of a comparison between Sⱼ(i) and Cⱼ(s).

13. The network entity of claim 12, wherein the at least one processor is further configured to select one or more sidelink radio resources (s) from the plurality of sidelink radio resources for communication between a wireless communication device and at least one neighboring wireless communication device on the basis of relative velocity of at least one of the transmitting wireless communication device or the at least one receiving wireless communication device with respect to wireless communication devices already at least one of transmitting or receiving in the sidelink radio resource (s).

14. A method for communication in a wireless communication network supporting a plurality of sidelink radio resources, wherein the method comprises:
at least one of:
measuring a first signal strength parameter (Pᵢⱼ) associated with at least one neighboring wireless communication device; or
measuring a second signal strength parameter (Iⱼ(s)) associated with at least one of the plurality of sidelink radio resources (s);
determining an interference-related parameter (Hⱼ(s)) associated with at least one of the plurality of sidelink radio resources (s);
at least one of:
computing a first map (Sⱼ) mapping an identity-related parameter (IDᵢ) of the at least one neighboring wireless communication device to Pᵢⱼ; or
computing a second map (Cⱼ) mapping at least one sidelink radio resource (s) to Iⱼ(s) or Hⱼ(s); and
transmitting at least one of Sⱼ or Cⱼ to at least one of a network entity or at least one neighboring wireless communication device.

15. The method of claim 14, wherein the method further comprises transmitting to the at least one neighboring wireless communication device at least one of a set (Tⱼ) of transmitting sidelink radio resources or a set (Rⱼ) of receiving sidelink radio resources of the wireless communication device.

16. A method for communication in a wireless communication network supporting a plurality of sidelink radio resources, wherein the method comprises:
receiving, from at least one neighboring wireless communication device, at least one of a first map (Sⱼ) mapping an identity-related parameter (IDᵢ) of the wireless communication device to a first signal strength parameter (Pᵢⱼ) or a second map (Cⱼ) mapping at least one sidelink radio resource (s) to a second signal strength parameter (Iⱼ(s)) or an interference-related parameter (Hⱼ(s));
receiving, from the at least one neighboring wireless communication device, at least one of a set (Tⱼ) of transmitting sidelink radio resources or a set (Rⱼ) of receiving sidelink radio resources of the wireless communication device; and at least one of:
selecting one or more sidelink radio resources (s) from the plurality of sidelink radio resources for communicating with the neighboring wireless communication device or with another wireless communication device on the basis of a comparison between Sⱼ(i) and Cⱼ(s); or
selecting one or more sidelink radio resources (s) from the plurality of sidelink radio resources for communicating with at least one neighboring wireless communication device on the basis of relative velocity of at least one of the transmitting wireless communication device or the at least one receiving wireless communication device with respect to wireless communication devices already at least one of transmitting or receiving in the sidelink radio resource (s).

17. A method for communication in a wireless communication network supporting a plurality of sidelink radio resources, wherein the communication network comprises a network entity and a plurality of wireless communication devices, wherein the method comprises:
receiving at the network entity, from a wireless communication device of the plurality of wireless communication devices, at least one of a first map (Sⱼ) mapping an identity-related parameter (IDᵢ) of at least one neighboring wireless communication device of the wireless communication device to a first signal strength parameter (Pᵢⱼ) or a second map (Cⱼ) mapping at least one sidelink radio resource (s) to a second signal strength parameter (Iⱼ(s)) or an interference-related parameter (Hⱼ(s)); and at least one of:
the network entity selecting one or more sidelink radio resources (s) from the plurality of sidelink radio resources for communication between the at least one neighboring wireless communication device and the wireless communication device or another wireless communication device on the basis of a comparison between Sⱼ(i) and Cⱼ(s); or the network entity selecting one or more sidelink radio resources (s) from the plurality of sidelink radio resources for communication between a wireless communication device and at least one neighboring wireless communication device on the basis of relative velocity of at least one of the transmitting wireless communication device or the at least one receiving wireless communication device with respect to the wireless communication devices already at least one of transmitting or receiving in the sidelink radio resource (s).
